(19) United States
(12) Patent Application Publication
(10) Pub. No.: US 2026/0167181 A1
(43) Pub. Date: Jun. 18, 2026

(54) SYSTEM AND METHOD FOR VEHICLE ALERTING

(71) Applicant: Torc Robotics, Inc., Blacksburg, VA (US)

(72) Inventors: Akshay Pai Raikar, Austin, TX (US); William Gray Davis, Austin, TX (US); Nicholas Atanasov, Austin, TX (US); Makarand Phatak, Austin, TX (US); Christopher Harrison, Austin, TX (US); Joseph R. Fox-Rabinovitz, Austin, TX (US)

(21) Appl. No.: 18/978,367

(22) Filed: Dec. 12, 2024

(51) Int. Cl. B60W 30/09; B60W 30/095; B60W 50/14; B60W 60/00

(52) U.S. Cl. CPC B60W 30/09; B60W 30/0956; B60W 50/14; B60W 60/0015; B60W 2554/402

(57) ABSTRACT

A system for vehicle alerting is provided. The system includes one or more environment sensors disposed at or near a road along which a vehicle passes. The system includes a processing device in communication with the one or more environment sensors. The processing device is configured to execute instructions stored in a memory to perform operations including detecting with the one or more environment sensors a living object at or near the road, and generating an alert regarding the detected living object at or near the road.

### TECHNICAL FIELD

The field of the disclosure relates to vehicle alerting and, in particular, to a system for detecting living objects along a route of a vehicle and alerting the vehicle and/or a user within the vehicle of the detected living object to avoid a potential collision with the living object.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

One aspect of planning technologies is detecting and avoiding potential collisions between living objects (e.g., animals) along the mission route and the vehicle. In particular, in a world where human development and wildlife habitats often intersect, the presence and entry of animals on roadways can pose significant challenges to autonomous vehicles, as well as traditional vehicles or semi-autonomous vehicles. In some instances, wildlife can enter and cross roadways in advance of a vehicle passing through the roadway. In some instances, wildlife can remain off the roadway and may enter the roadway immediately before the vehicle passes a certain area, resulting in a collision. Such collision can damage sensors located on the vehicle, which not only necessitates expensive maintenance, but can result in the vehicle being impaired for further travel along the mission route. Such collisions can further be harmful for individuals within the vehicle.

Accordingly, there exists a need for a system and a method of vehicle alerting when living objects are detected in the vicinity of the roadway to reduce collisions between the vehicle and the living objects. These and other needs are met by the exemplary system for vehicle alerting discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for vehicle alerting is provided. The system includes one or more environment sensors disposed at or near a road along which a vehicle passes. The system includes a processing device in communication with the one or more environment sensors. The processing device is configured to execute instructions stored in a memory to perform operations including detecting with the one or more environment sensors a living object at or near the road. The operations include generating an alert regarding the detected living object at or near the road.

In some embodiments, the one or more environment sensors can include at least one of an infrared camera, or LiDAR (or combinations thereof). The operations can include detecting with the one or more environment sensors whether the living object is moving towards or away from the road. The operations can include generating a trajectory vector for the living object moving towards or away from the road. The trajectory vector is representative of a speed of the living object. The living object can be an animal (e.g., a wild animal, or the like). The operations can include identifying a type of the animal detected by the one or more environment sensors.

The operations can include transmitting the alert to a user interface associated with the vehicle. The operations can include transmitting the alert to a smart device (e.g., a mobile device, or the like) of a user traveling in the vehicle. The operations can include transmitting the alert to other surrounding vehicles within a predetermined radius. The operations can include transmitting the alert from the primary vehicle to other vehicles in a fleet within a predetermined radius or with mission routes passing through the same area as the primary vehicle.

In some embodiments, the operations can include collecting historical data of detected living objects and generating migration patterns for the detected living objects. The operations can include generating a mission route for the vehicle based on the migration patterns (e.g., to avoid areas known for an increased number of living objects/animals), thereby decreases instances of collisions with living objects.

The system can include one or more vehicle sensors associated with the vehicle. In some embodiments, the one or more vehicle sensors can be configured to detect the living object as the vehicle approaches the living object. The operations can include transmitting the alert to the vehicle, and the vehicle includes a vehicle processing device configured to adjust operation of the vehicle based on the alert. The vehicle can be, e.g., an autonomous vehicle, a semi-autonomous vehicle, or any type of vehicle (e.g., a passenger operated vehicle). In some embodiments, adjusting operation of the vehicle based on the alert can include automatically decelerating the vehicle. In some embodiments, the one or more environment sensors can be configured to detect the living object within about, e.g., a 1,600 ft radius, or the like around the respective environment sensors. In some embodiments, the operations can include transmitting the alert to the vehicle when the vehicle is within a predetermined distance (e.g., about 1 mile, 0.5 miles, or the like) of the one or more environment sensors detecting the living object.

In another aspect, an exemplary computer-implemented method for vehicle alerting is provided. The method includes detecting with one or more environment sensors a living object at or near a road. The one or more environment sensors can be disposed at or near the road along which a vehicle passes. The method includes executing instructions stored in a memory with a processing device in communication with the one or more environment sensors to perform operations including generating an alert regarding the detected living object at or near the road.

The operations can include detecting with the one or more environment sensors whether the living object is moving towards or away from the road. The operations can include transmitting the alert to a user interface associated with the vehicle. The operations can include transmitting the alert to the vehicle, such that the vehicle itself (or mission control) adjusts operation of the vehicle to reduce a chance of collision with the detected living object (e.g., deceleration of the vehicle, or the like).

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for vehicle alerting.

FIG. 7 is a flowchart of a method for vehicle alerting.

FIG. 8 is a flowchart of a method for vehicle alerting based on detection of an animal in the vicinity of a road.

FIG. 9 is a flowchart of a method for vehicle alerting based on migration patterns for animals.

FIG. 10 is a diagrammatic view of an exemplary system for vehicle alerting.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

A living object: A living object is any type of moving object, such as an animal, or a human. In some instances, a living object refers to wildlife typically found in environments surrounding a highway, such as deer, birds, or the like. In some instances, a living object can be any living or non-living moving object, such as debris. In some instances, a living object refers to an unmanned aerial vehicle and/or drone, e.g., if such vehicle/drone loses contact with the RC controller and flies blindly into the path of a vehicle.

The exemplary system for vehicle alerting can be used for autonomous vehicles, semi-autonomous vehicles, or non-autonomous vehicles to assist with avoiding collisions with living objects (e.g., animals) that may cross the roadway. The system can include environment sensors disposed along the side of the roadway that detect living objects around or on the roadway. The data from the sensors can be used to identify the type of living object (e.g., type of animal) and the trajectory of the living objects to determine if an alert should be issued to the vehicle. For example, if the living object is determined to be a deer traveling away from the road or a smaller animal (such as a squirrel) traveling away or towards the road, no alert can be issued. However, if the living object is determined to be a deer traveling towards the road or located within a predetermined distance from the road, an alert can be issued to the vehicle.

In some embodiments, a smart road can include advanced camera/sensor technologies, such as infrared (IR) heat signature and/or visible light tracking, to monitor and track the movement patterns of various animal species. The system not only identifies the specific species, but also creates a comprehensive, long-term map of the behavior of the animals and migratory routes in combination with satellite imaging corresponding to animal migration patterns. The system can therefore use the historical data to estimate migratory patterns and behaviors of animals over time, allowing mission control to generate routes for the vehicle that seek to avoid areas with high instances of animals (or placing the vehicle on “high alert” when entering areas known to have a larger population of animals).

The system can rely on passive and active sensors (such as camera IR sensors, LiDAR, or the like) to detect and identify animals, and tracks them to ascertain whether the animals will ingress through road boundaries. In some embodiments, the sensor data can be combined with applicable geographic information systems (GIS) available through satellite imaging/mapping services to correlate it with animal activity in the region of concern. The satellite or historical data can be used to determine current animal presence and predict future/expected animal presence in certain areas surrounding the roadway. In instances where animal crossings intersect with human infrastructure, the gathered information can be used to inform the vehicle of a higher risk of animal interaction/collision. For example, the data can be used to adjust operation of the vehicle behavior (e.g., deceleration) and enhances road safety by alerting drivers to the potential animal presence, prompting appropriate responses through direct communication with the vehicle or passive communication signals (such as beacons).

In some embodiments, the data can be used to assist with preservation of wildlife environments during construction of infrastructure. For example, the gathered information can be used to inform the construction of overpasses or underpasses, ensuring the safety and preservation of both wildlife and human communities. In some embodiments, the data can be used to guide construction of fences to influence the animals to select alternate routes, if needed. In some embodiments, the gathered data can be shared with road authorities on the number of animal-vehicle collisions, which would drive changes in posted speed limits and/or warnings.

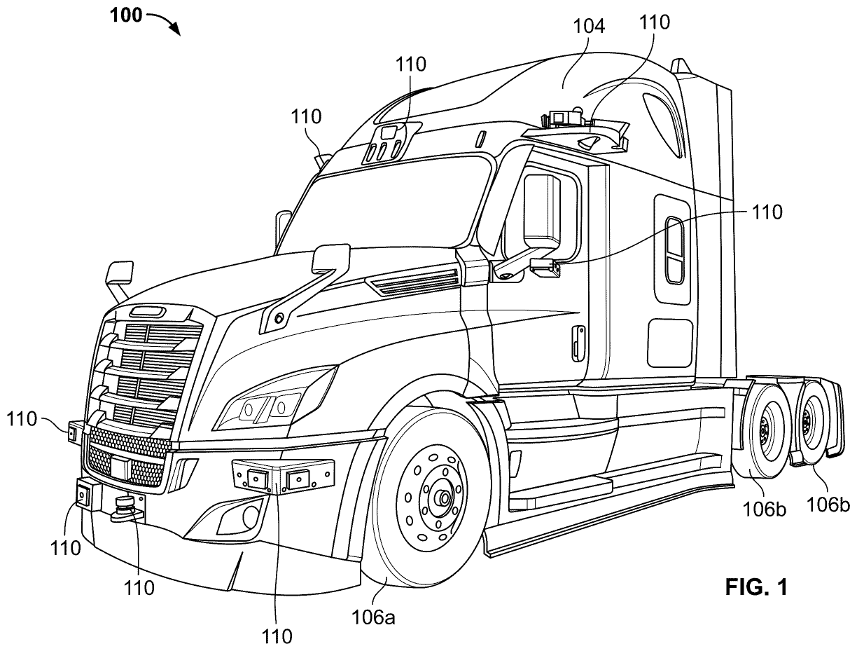

Various embodiments in the present disclosure are described with reference to FIGS. 1-10 below.

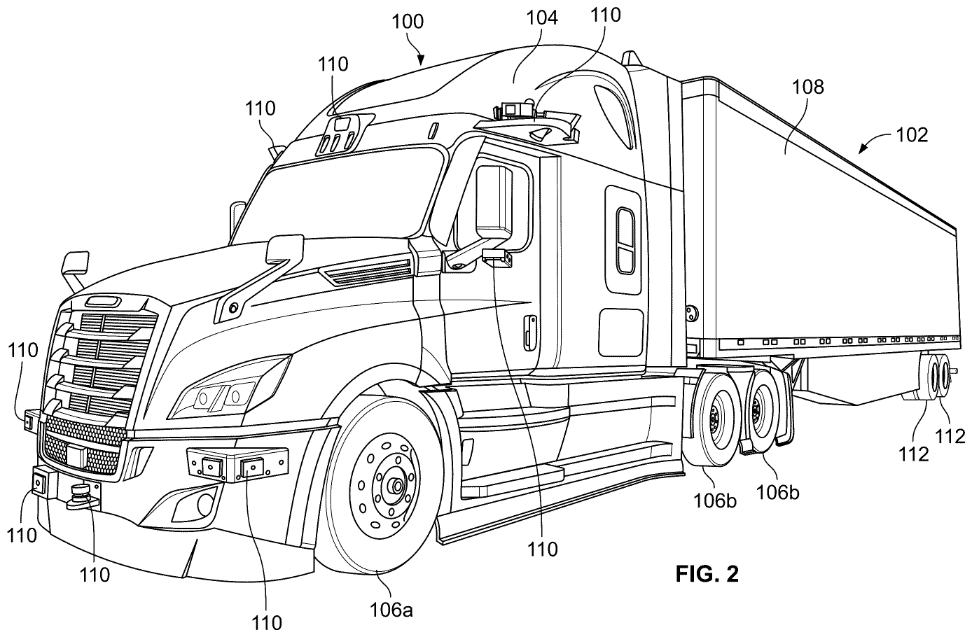

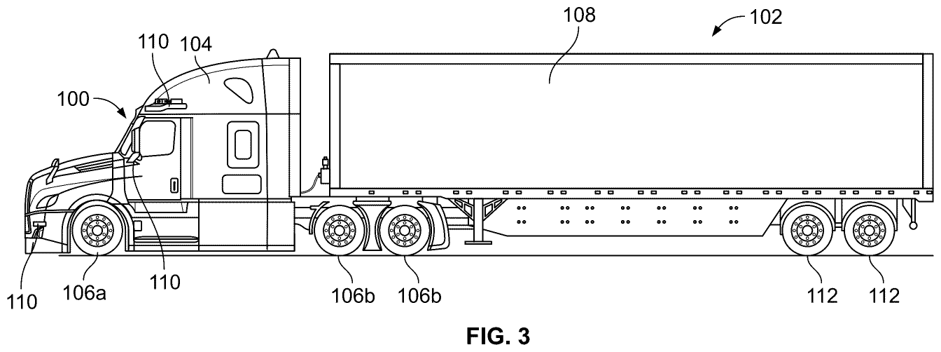

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

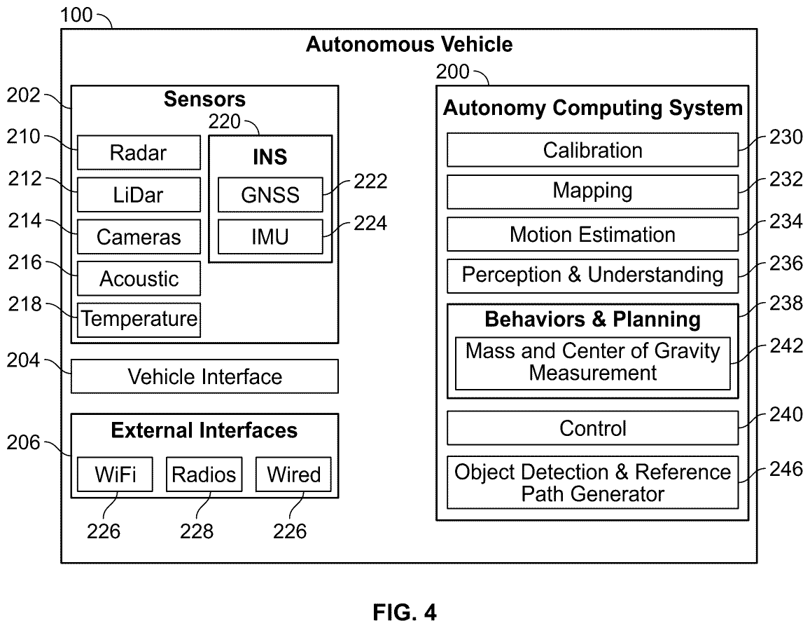

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

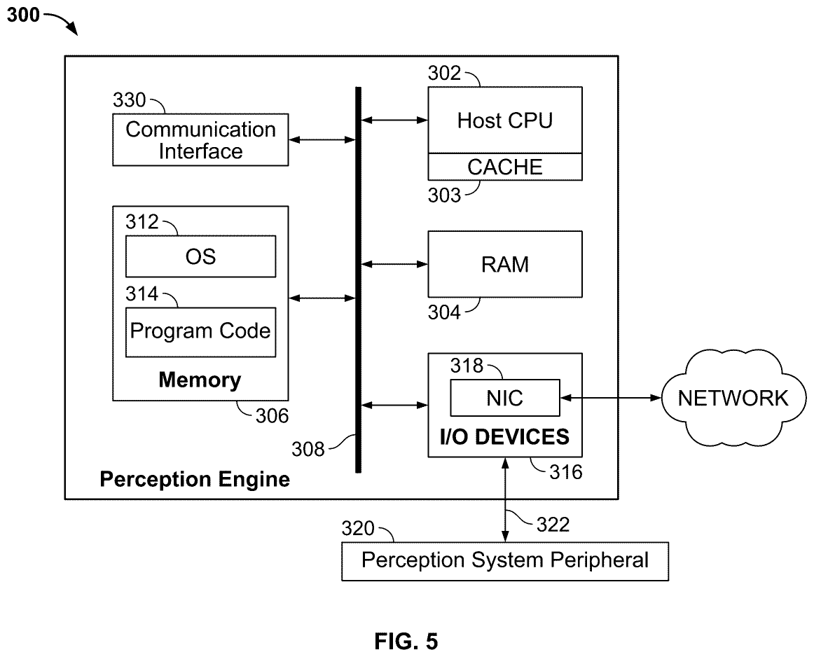

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

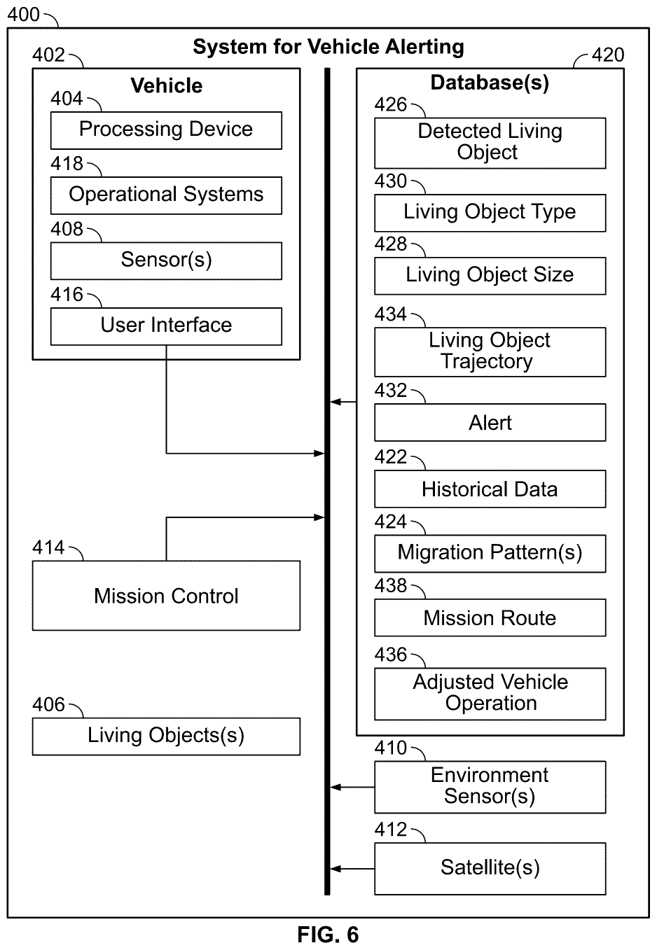

FIG. 6 is a block diagram of an exemplary system 400 for vehicle alerting. The system 400 generally includes one or more vehicles 402 (e.g., autonomous vehicle 100, or any type of vehicle). Each vehicle 402 includes a processing device 404 (e.g., computing system 200, computing system 300, or the like) configured to receive and process data for determining and generating an alert to the vehicle based on detection of one or more living objects 406 near a road along which the vehicle 402 is traveling. In some embodiments, at least some of the data received by the processing device 404 can be data from one or more sensors 408 (e.g., sensors 202) of the vehicle 402. In some embodiments, at least some of the data received by the processing device 404 can be data from one or more environment sensors 410 disposed along sides of the road. In some embodiments, at least some of the data received by the processing device 404 can be data from one or more satellites 412 with migratory patterns of animals in the environment around the road.

In some embodiments, the processing device can be located at mission control 414, which determines whether an alert should be issued to the vehicle 402 and/or a user interface 416 associated with the vehicle 402 (or associated with a user device for an individual within the vehicle 402). Based on detection of a living object 406 and issuance of an alert, the system 400 can be used to adjust operation of one or more operational systems 418 (e.g., computing system 200) of the vehicle 402 in an effort to avoid a collision with the living object 406 (e.g., deceleration to a predetermined threshold speed, a full stop, or the like). The vehicle 402 can include one or more databases 420 (e.g., memory 306) configured to receive and electronically store data. In some embodiments, the database 420 can be stored externally from the vehicle 402 (e.g., at mission control 414, or the like) and the vehicle 402 can be in communication with the external database 420 for receiving and/or transmitting data associated with the system 400.

The environment sensors 410 can be positioned at predetermined distances from each other along the side of the road on opposing sides of the road. For example, the environment sensors 410 can be installed in the field or grass surrounding the road. Each sensor 410 can include, e.g., an infrared camera, LiDAR, an RGBD camera, a microphone, combinations thereof, or the like. Each sensor 410 can be configured to detect a living object 406 within a predetermined radius or field-of-view of the sensor 410. In some embodiments, the radius can be about, e.g., 1,600 ft, 700 ft, 300 ft, or the like. However, other radii can be used as long as the coverage areas of the sensors 410 overlap along the road to ensure coverage and detection on sides of the road and on the road itself. Such overlap avoids blind spots of detection for the system 400.

In some embodiments, the environment sensors 410 can each include solar panels as a power source for operating the sensors 410. Each sensor 410 can include a transmitter/receiver (e.g., Bluetooth, WiFi, radio frequency, or the like) for transmitting data to the vehicle 402 and/or mission control 414. The data from the sensor 410 can also be transmitted to the database 420 for storage and collection of historical data 422 associated with detection of living objects 406 in specific areas of the road. For example, the historical data 422 can include details of the living object 406 detected, including the type, size, location, time, date, or the like. The historical data 422 can also include data received from the satellite 412 indicative of detected migration patterns 424 of the living objects 406.

When the living object 406 enters the field-of-view of the sensor 410, the sensor 410 can transmit a first signal indicative of a detected living object 426 (e.g., perceived movement). The sensor 410 can be used to detect certain characteristics of the detected living object 426, such as the size 428 or other identifiable characteristics (e.g., horns, fur, or the like). In some embodiments, the sensor 410 can detect, e.g., the gait, movement pattern, or the like, to help identify the type of living object 426. For example, a bear and a deer have different movement patterns, and this information can be used to more accurately identify the type of living object 426 detected. The detected characteristics can be used to estimate (based on historical data) the type 430 of living object 406 detected by the sensors 410.

The system 400 can use the detected characteristics to determine if the detected living object 426 would create significant damage to a vehicle 402 if a collision occurred, and if an alert 432 should be issued. For example, for certain smaller animals (e.g., squirrels, snakes, or the like), an alert 432 can be avoided since damage to the vehicle 402 would not occur. In some embodiments, the system 400 can generate a bounding box around the detected living object 426, and the bounding box can be used to identify the dimensions of the living object 426. In some embodiments, a detected height of the living object 426 can be used as a threshold for determining whether the alert 432 should be transmitted to the vehicle 402. For example, if the detected living object 426 is below a threshold height, e.g., 1 ft, 2 ft, or the like, an alert 432 is not transmitted to the vehicle 402. In all other instances, the alert 432 can be transmitted to warn the vehicle 402. Thus, for larger animals (e.g., deer, bears, cows, mountain lions, or the like), the alert 432 can be issued. As a further example, the living object 406 can be a human and the system 400 can identify the human in order to issue an alert to the vehicle 402 if the human is moving closer to the road. Such selective alert 432 generation can avoid unnecessary notifications to the vehicle 402 when the danger to the vehicle 402 or its passengers is essentially zero. In some embodiments, if the vehicle 402 is unable to avoid a collision with the detected living object 426, another alert can be transmitted by the vehicle 402 to mission control and/or local authorities regarding the collision and the location of an injured living object 426 to manage road maintenance.

The system 400 can similarly determine or estimate the trajectory 434 of the detected living object 426 from the sensor 410 data, and uses this data to determine if an alert 432 should be issued to the vehicle 402. The trajectory 434 can include the direction and speed of travel for the detected living object 426. If the trajectory 434 shows that the detected living object 426 is moving away from the road, the alert 432 need not be generated. In some instances, even if the trajectory 434 shows the object 426 moving away from the road, the distance of the object 426 relative to the road can still be used to issue an alert 432 if the object 426 is within a predetermined distance. However, if the trajectory 434 shows that the object 426 is moving towards the road, the alert 432 can be generated. In some embodiments, the alert 432 can be generated if the object 426 is moving towards the road and is within a predetermined threshold distance from the road, e.g., 15 ft, 20 ft, 25 ft, or the like. In some embodiments, the threshold distance from the road can be dependent on the speed of the object 426. For faster moving objects 426, the distance from the road can be greater as compared to slower moving objects 426.

In some embodiments, the alert 432 can only be issued if the vehicle 402 is within a predetermined distance (e.g., about 0.5 miles, 0.75 miles, or the like) from the detected living object 426. Until the vehicle 402 enters this distance threshold, no alert 432 can be issued to avoid unnecessary notifications to the vehicle 402. If an alert 432 is issued to the vehicle 402, the vehicle 402 can automatically enter an adjusted vehicle operation 436 mode for the operational systems 418. The operation 436 can be intended to reduce the chance of a collision with the detected living object 426, and allows the vehicle 402 (or the individual operating the vehicle 402) to have more time to stop or swerve to avoid the detected living object 426, if needed. As an example, the operation 436 can include deceleration of the vehicle 402 to a predetermined threshold speed to ensure the vehicle 402 can come to a complete stop, if needed. The predetermined threshold speed can be based on the type of road along which the vehicle 402 travels. For example, the vehicle 402 can reduce its speed to about 20% below the speed limit to offer a safety buffer for avoiding the object 426 if deceleration or maneuvering may be needed. In some embodiments, the rate of deceleration can be about 2.5 m/s², or the like.

The operation 436 can also depend on where the object 426 has been detected. For example, if the object 426 has been detected on the road itself or immediately adjacent to the road, the operation 436 can decelerate the vehicle 402 at a greater rate to avoid the higher chance of a collision. It should be noted the operation 436 is taken in a manner to avoid collisions with other vehicles along the road, ensuring a safe adjustment. After the vehicle 402 has passed the area of the road where objects 406 have been detected, the vehicle 402 can return to a normal operation mode (which is different form the adjusted vehicle operation 436). The system 400 can therefore use the data from environment sensors 410 to reduce chances of a collision with living objects 406 around or on the road.

The sensors 408 associated with the vehicle 402 can be used in a similar manner to detect living objects 406 around the road. For example, in some embodiments, the sensors 408 of the vehicle 402 can be used on their own to alert 432 the vehicle 402 of detected living objects 426 (without the use of environment sensors 410). The sensors 408 include a field-of-view facing outward away from the vehicle 402. In some embodiments, the field-of-view can be sufficiently far from the vehicle 402 to allow the sensors 408 to detect a living object 426 and adjust operation of the vehicle 402 to avoid a collision with the object 426 (e.g., a 500 meters radius, or more). In some embodiments, the field-of-view can be about 230° with a center point at the front of the vehicle 402.

In some embodiments, the data from the sensors 408 can be used to supplement the data from the environment sensors 410. For example, the data from the sensors 410 can be used to alert 432 the vehicle 402, and operation of the vehicle 402 can be adjusted based on the environment sensors 410. However, as the vehicle 402 approaches the potential collision area where the detected living object 426 is located, the sensors 408 of the vehicle 402 can be used to reinforce the original estimations of the characteristics of the detected living object 426 and provide more detail about the object 426. For example, the sensors 408 can be used to confirm that the object 426 is indeed still in the area and the sensors 410 have accurately identified the object 426. As a further example, the sensors 408 can be used to confirm or clarify the type 430, size 428 and/or trajectory 434 of the object 426. As a further example, the sensors 408 can be used to identify when/if a collision with the detected living object 426 occurs. As such, in some embodiments, the sensors 408, 410 can be used in combination to improve the overall accuracy of the system 400.

In some embodiments, once the vehicle 402 has been alerted, the vehicle 402 can be used to transmit similar alerts 432 to other vehicles in a fleet (or other surrounding vehicles generally) to warn individuals/vehicles of potential collision risks. The alert 432 can include all available details on the detected living object 426, such as the type 430, size 428, trajectory 434, or the like. The alert 432 can also indicate on which side of the road the object 426 has been detected (e.g., geographical coordinates of the object 426). In some embodiments, the alert 432 can be transmitted as a text message to a user device to one or more users within the vehicle 402.

In some embodiments, the data from the system 400 can be used to assist with planning of the mission route 438 of the vehicle 402 (or other vehicles). The historical data 422 and/or the migration patterns 424 can be used to determine areas that have higher instances of detected living objects 426. For example, the data can indicate that during certain parts of the year (e.g., seasonally), some roads have higher instances of living objects 406 as compared to other parts of the year. The system 400 (e.g., mission control 414) can use this data to generate a mission route 438 for the vehicle 402 or other vehicles that seek to avoid certain roads to reduce the chances of collisions with living objects 406. In some embodiments, the system 400 can adjust the speed for the vehicle 402 during mission planning based on the seasonal living object data. The system 400 can therefore operate as both a real-time (or substantially real-time) safety operation for the vehicle 402, as well as a route planning system for determining the safest route for the vehicle 402 in the future.

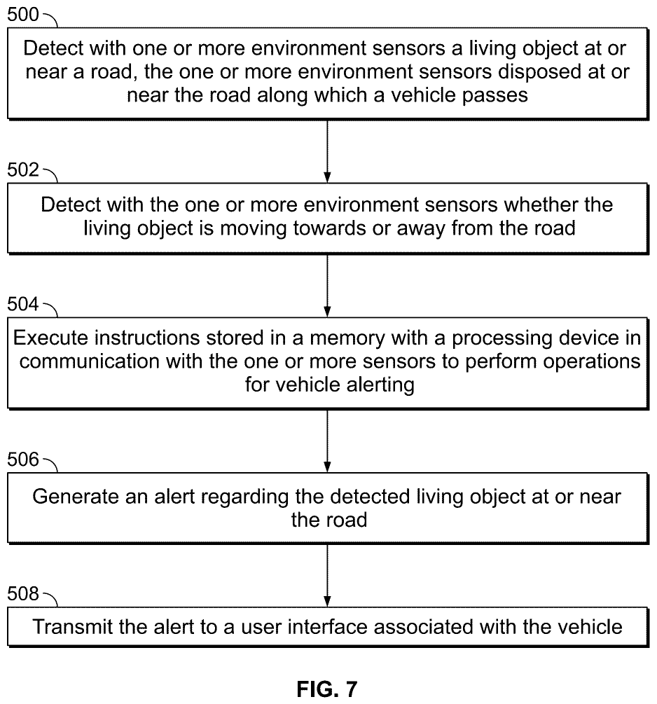

FIG. 7 is a flowchart of a method of vehicle alerting by the exemplary system 400 discussed herein. At 500, a living object can be detected with one or more environment sensors at or near a road. The one or more environment sensors can be disposed at or near the road along which a vehicle passes. At 502, the one or more environment sensors can be used to detect whether the living object is moving towards or away from the road (e.g., trajectory). At 504, instructions stored in a memory can be executed with a processing device in communication with the one or more sensors and the database to perform operations for vehicle alerting. At 506, an alert regarding the detected living object at or near the road can be generated. At 508, the alert can be transmitted to a user interface associated with the vehicle or an individual's device within the vehicle.

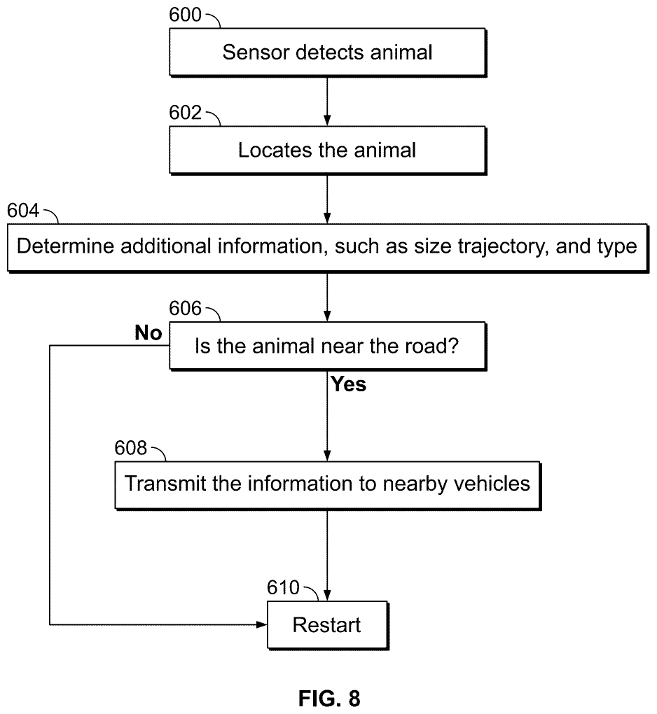

FIG. 8 is a flowchart of a method of vehicle alerting by the exemplary system 400 discussed herein, including detection of an animal in the vicinity of the road. At 600, the sensor (whether environment or at the vehicle) detects an animal. At 602, based on the data from the sensor, the location of the animal is detected. At 604, the system determines additional information associated with the detected animal, such as the size, trajectory and type. At 606, the system determines if the animal is near the road based on the sensor data (e.g., within 15 ft, 20 ft, 25 ft, or the like). If the animal is not near the road, the system can restart at 610. If the animal is near the road, at 608, the system can transmit the information regarding the detected animal to all nearby vehicles.

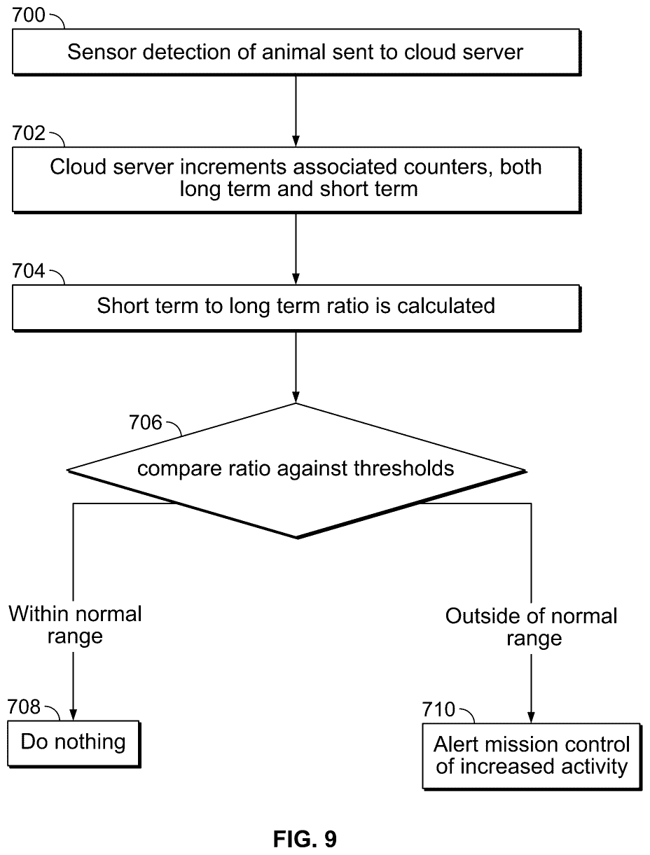

FIG. 9 is a flowchart of a method of vehicle alerting by the exemplary system 400 discussed herein, including usage of migration patterns. At 700, the data associated with detection of an animal with the sensor can be transmitted to a cloud server. At 702, the cloud server can increment associated counters, both long term and short term. Short time refers to sightings in the past shorter period of time (e.g., past week), and long term refers to sightings in the past longer period of time (e.g., past year). At 704, the short term to long term ratio can be calculated. The ratio can be calculated as short term/long term. At 706, the ratio is compared to predetermined thresholds. If the ratio is within a normal range (relative to the threshold), at 708, the system takes no action. If the ratio is determined to be outside normal ranges (relative to the threshold), at 710, the system can alert mission control or the vehicle of increased activity. The predetermined thresholds can consider normal range to be anything less than a value of 1.2 (20% above the annual average).

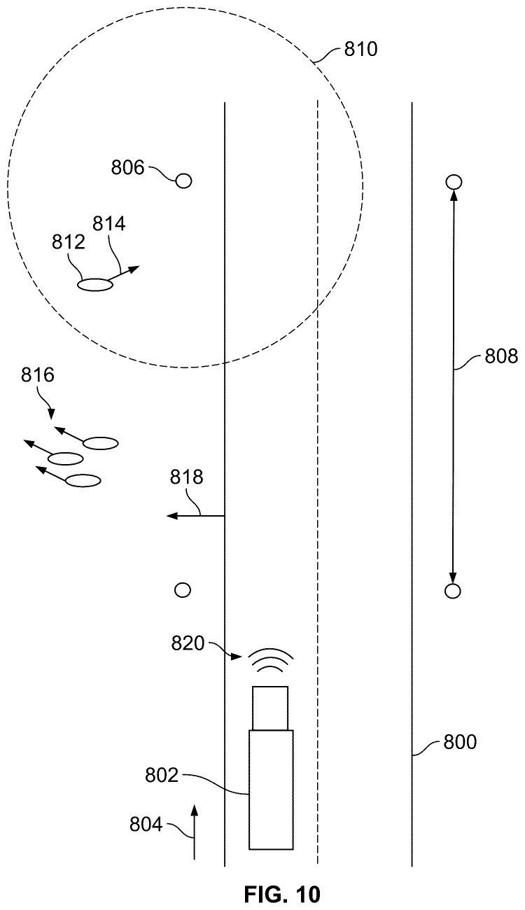

FIG. 10 is a diagrammatic view of an exemplary system for vehicle alerting, as discussed herein. FIG. 10 shows a two-lane road 800 with a vehicle 802 traveling in a direction 804. On both sides of the road 800, the system includes environment sensors 806. The sensors 806 are spaced from each other by a distance 808 which ensures that the field-of-view radius 810 for the adjacently positioned sensors 806 overlap. This avoids blind spots in the coverage area provided by the sensors 806. The sensors 806 are positioned offset from the road 800 itself, while the radius 810 provides coverage on both the road 800 and to the sides of the road 800. This allows for detection of animals on both the road 800 and around the road 800.

If the sensor 806 detects a perceived motion within the radius 810 of coverage, the system can identify a living object 812. Based on the detected characteristics associated with the object 812, the system can estimate the type and size of the object 812, as well as the trajectory 814. As illustrated in FIG. 10, the trajectory 814 of the living object 812 is towards the road 800. As such, an alert can be issued to the vehicle 802 to enter an adjusted operation mode to avoid a potential collision with the object 812 if it enters the road 800. As a further example, other living objects 816 detected by the sensors 806 can indicate trajectories away from the road 800 and, therefore, an alert is not issued about these living objects 816. In some embodiments, the detected living object 812 must be within a predetermined minimal distance 818 from the side of the road 800 before the alert is issued to the vehicle 802. In some embodiments, sensors 820 associated with the vehicle 802 can be used to either supplement data from the sensors 806 or to identify the living objects 812, 816 and their characteristics to determine the vehicle 802 operation.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for vehicle alerting, comprising:
one or more environment sensors disposed at or near a road along which a vehicle passes; and
a processing device in communication with the one or more environment sensors, wherein the processing device is configured to execute instructions stored in a memory to perform operations comprising:
detecting with the one or more environment sensors a living object at or near the road; and
generating an alert regarding the detected living object at or near the road.

2. The system of claim 1, wherein the one or more environment sensors include at least one of an infrared camera, or LiDAR.

3. The system of claim 1, wherein the operations comprise detecting with the one or more environment sensors whether the living object is moving towards or away from the road.

4. The system of claim 3, wherein the operations comprise generating a trajectory vector for the living object moving towards or away from the road, the trajectory vector representative of a speed of the living object.

5. The system of claim 1, wherein the living object is an animal.

6. The system of claim 4, wherein the operations comprise identifying a type of the animal detected by the one or more environment sensors.

7. The system of claim 1, wherein the operations comprise transmitting the alert to a user interface associated with the vehicle.

8. The system of claim 1, wherein the operations comprise transmitting the alert to a smart device of a user traveling in the vehicle.

9. The system of claim 1, wherein the operations comprise collecting historical data of detected living objects and generating migration patterns for the detected living objects.

10. The system of claim 1, wherein the operations comprise generating a mission route for the vehicle based on the migration patterns.

11. The system of claim 1, comprising one or more vehicle sensors associated with the vehicle.

12. The system of claim 11, wherein the one or more vehicle sensors are configured to detect the living object as the vehicle approaches the living object.

13. The system of claim 1, wherein the operations comprise transmitting the alert to the vehicle, and the vehicle includes a vehicle processing device configured to adjust operation of the vehicle based on the alert.

14. The system of claim 13, wherein the vehicle is an autonomous vehicle.

15. The system of claim 13, wherein adjusting operation of the vehicle based on the alert includes automatically decelerating the vehicle.

16. The system of claim 1, wherein the one or more environment sensors are configured to detect the living object within a 1,600 ft radius around the respective environment sensors.

17. The system of claim 1, wherein the operations comprise transmitting the alert to the vehicle when the vehicle is within 1 mile of the one or more environment sensors detecting the living object.

18. A computer-implemented method for vehicle alerting, comprising:
detecting with one or more environment sensors a living object at or near a road, the one or more environment sensors disposed at or near the road along which a vehicle passes; and
executing instructions stored in a memory with a processing device in communication with the one or more environment sensors to perform operations comprising:
generating an alert regarding the detected living object at or near the road.

19. The computer-implemented method of claim 18, wherein the operations comprise detecting with the one or more environment sensors whether the living object is moving towards or away from the road.

20. The computer-implemented method of claim 18, wherein the operations comprise transmitting the alert to a user interface associated with the vehicle.
